(19) United States
(12) Patent Application Publication
(10) Pub. No.: US 2006/0108834 A1
(43) Pub. Date: May 25, 2006

(54) Motor vehicle body comprising a support structure composed of large-size partial modules

(76) Inventors: Olivier Boulay, Tokyo (JP); Konrad Eipper, Rottenburg (DE); Wolfgang Fussnegger, Tuebingen (DE); Juergen Knothe, Gaertringen (DE); Jan Krueger, Stuttgart (DE); Joerg Langner, Schoenaich (DE); Hubert Scheper, Weil der Stadt (DE); Bernhard Spies, Sindelfingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/525,948

(22) PCT Filed: Aug. 8, 2003
(86) PCT No.: PCT/EP03/08818

§ 371 Date: Sep. 21, 2005

(30) Foreign Application Priority Data
Aug. 27, 2002 (DE) 10239992.1

(51) Int. Cl. B62D 25/00

(52) U.S. Cl. 296/193.04

(57) ABSTRACT

The invention relates to a motor vehicle body, the support structure (10) of which is composed of large-size partial modules (12, 34, 50, 66), a basic module (12) comprising lateral longitudinal members (15) and a body floor (14) and reaching laterally as far as front wall columns (20), and, when the support structure (10) is assembled, the basic module (12) being connected to a front end module (34) which belongs to the front crumple zone of the motor vehicle and is supported in a crash stable manner on the basic module (12).

In order to provide a motor vehicle body, in which the front end module (34) even without a roof construction is fixed in a sufficiently stable manner on the basic module (12), a front end region (36) of the body floor (14) belongs to the front end module (34) and extends rearward over a considerable length region of the basic module (12) between lateral longitudinal member sections (16).

### BACKGROUND AND SUMMARY OF THE INVENTION

This invention relates to a motor vehicle body.

A body having a support structure which is composed of essentially four large-size partial modules, is already known from German publication DE 198 33 395 A1. One of the partial modules is designed as a basic module, which reaches laterally as far as front wall columns and has lateral longitudinal members and a body floor. When the support structure is assembled, the basic module is connected to a partial module, which is designed as a front end module, belongs to the front crumple zone of the motor vehicle, and is supported in a crash stable manner on the basic module. By supplementing the basic module and the front end module with a roof module, or by roof sections provided at the front end of the basic module, a stable connection of the front end module to the basic module is produced.

This invention has as one object the object of providing a motor vehicle body, in which the front end module is fixed in a sufficiently stable manner to the basic module even without a roof construction.

This object is achieved according to the invention by the claimed features.

Advantageous refinements of the invention are apparent from the dependent claims.

In body support structure according to the invention, a front end region of the body floor belongs to the front end module, which region extends rearward over a considerable length region of the basic module between lateral longitudinal member sections. This provides a particularly stable support of the front end module on the basic module of the support structure, so that, for example in the case of a head-on crash, a desired deformation sequence is achieved, in which the front end structure acts in a particularly effective manner as an energy-absorbing crumple zone and the shape of the passenger safety cell together with the floor is maintained to the greatest possible extent. The very stable fastening of the front end module to the basic module enables the support structure to be used for vehicles of different construction, since the front end module is fastened in a sufficiently stable manner to the basic module even without a roof construction. This also renders the support structure particularly suitable for open motor vehicles.

A particularly stiff and stable connection of the front end module to the basic module is provided if the front end module has longitudinal member sections which laterally bound the front end region of the body floor and are to be connected to the lateral longitudinal member sections of the basic module. In this case, the connection between the front end module and basic module is particularly stable if the mutually assigned, lateral longitudinal member sections of the front end module and of the basic module are connected to each other via joining surfaces matched to one another, the joining surfaces extending over the at least approximately entire overlapping length of the mutually assigned longitudinal member sections or of the two modules.

The stability of the connection of the front end module to the basic module is further assisted by the lateral longitudinal member sections of the front end module and of the basic module each having a box profile which is closed in cross section. After the longitudinal member sections which are assigned to one another in each case are joined together, lateral longitudinal members which have a box profile, which is doubled in cross section, and are particularly stiff are therefore provided.

If upwardly protruding column sections are arranged at the front ends of the lateral longitudinal member sections of the basic body, then the front end module and the basic module can also be connected to each other in the vertical direction, and a stable fastening of the two modules arises overall. In this case, the upwardly protruding column sections preferably extend approximately at right angles to the direction of extent of the longitudinal members.

In a further refinement of the invention, the front end module also comprises upwardly protruding column sections which are fastened to the lateral longitudinal member sections thereof. This enables the mutually assigned, upwardly protruding column sections of the front end module and of the basic module to be connected to each other via joining surfaces, which are matched in each case to each other, to form front door columns, so that, on the one hand, a particularly good connection of the front end module to the basic module is produced and, on the other hand, stiff and stable door columns are provided-preferably up to the level of the side wall edge of the support structure. A front end wall which stiffens the door columns in the transverse direction of the vehicle preferably extends between the door columns.

The upwardly protruding column sections of the front end module and of the basic module preferably each comprise a box profile which is closed in cross section, so that, after the column sections which are assigned to one another laterally in each case are joined together, particularly stiff door columns with a box profile which is doubled in cross section are provided.

After the large-size partial modules have been assembled, the support structure is to be lined with outer panel parts which cover the joining points of the partial modules with the outer panel parts. This ensures that, on the one hand, the partial modules can be joined with sufficient tolerances in a simple manner in terms of manufacturing and therefore cost-effectively and, on the other hand, that the joining points are covered, giving an impression of high quality.

Further advantages, features and details of the invention emerge from the description below of a preferred exemplary embodiment and with reference to the drawings.

### BRIEF DESCRIPTION OF THE DRAWINGS

FIG. 1 is a perspective exploded illustration of the support structure of the motor vehicle body according to the invention, which support structure is assembled from large-size partial modules;

FIG. 2 shows a further perspective exploded illustration of the support structure which is assembled from partial modules and is lined with outer panel parts;

FIG. 3 shows a perspective view of a partial module of the support structure designed as a front end module;

FIG. 4 shows a perspective view of a partial module of the support structure designed as a basic module;

FIGS. 5a and 5b each show partial perspective views of the basic module and the front end module before they have been joined together;

FIG. 6 shows a perspective view of the basic module and of the front end module after they have been joined together;

FIG. 7 shows a perspective view of a partial module of the support structure designed as a rear module;

FIG. 8 shows a perspective view of a partial module of the support structure designed as a roof module; and

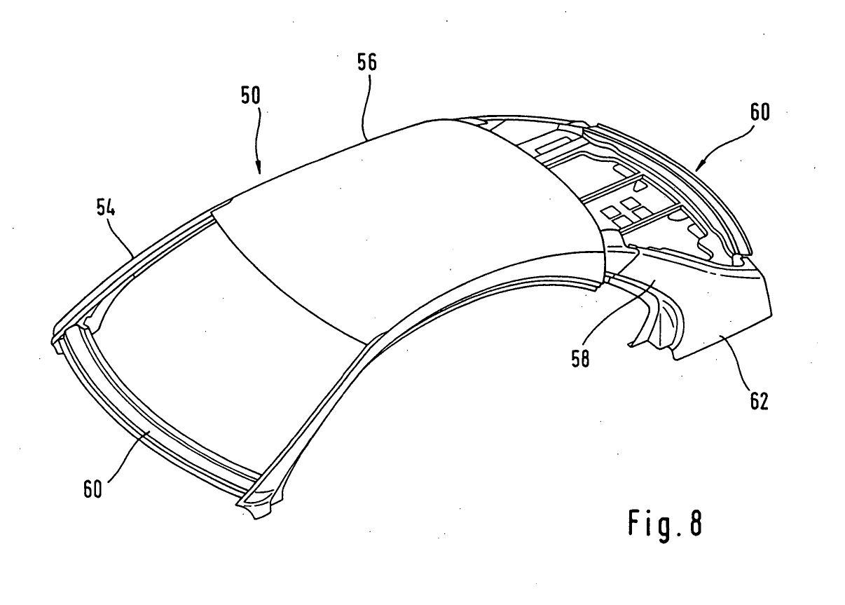

FIG. 9 shows a partial perspective view of the assembled support structure which in each case comprises a left and a right side wall module.

### DETAILED DESCRIPTION OF THE INVENTION

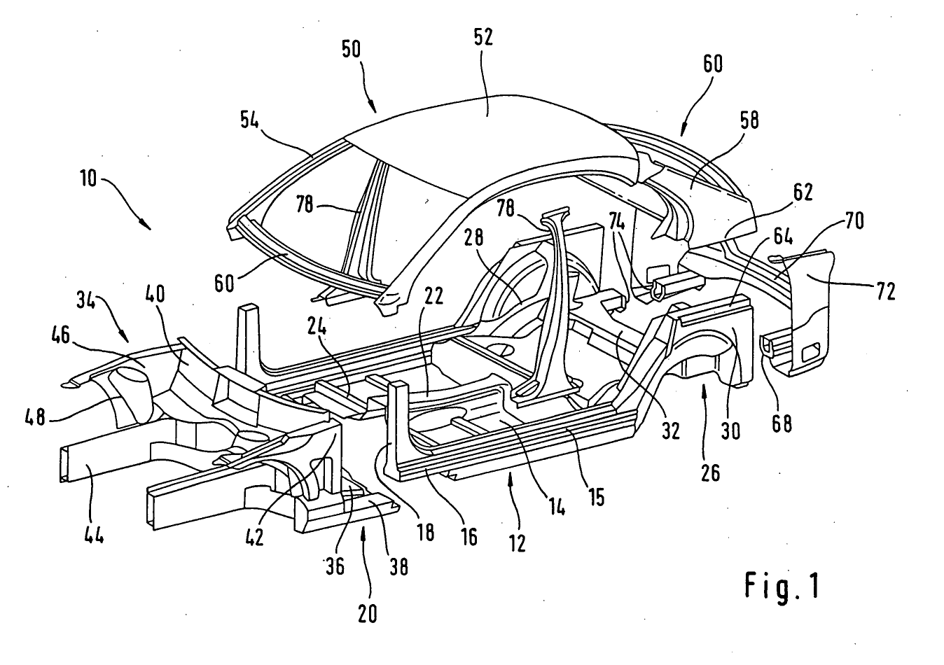

FIG. 1 shows, in a perspective exploded illustration, a support structure 10 of a motor vehicle body that is assembled from a plurality of large-size partial modules which are described in more detail below. In the exemplary embodiment shown here, the partial modules of the support structure 10 are produced in each case from a plurality of sheet-metal parts joined together; at the same time, however, the partial modules may also be premanufactured in different constructions, for example as a “space frame”, as plastic parts, metal cast parts, as components in a “sandwich construction” or the like. In particular, combinations of different constructions are also conceivable here for the joined together partial modules, depending on application and loading. The individual modules are joined together in particular via bonding connections, welding connections or the like. At the same time, other customary connections, such as screw connections or the like, are conceivable.

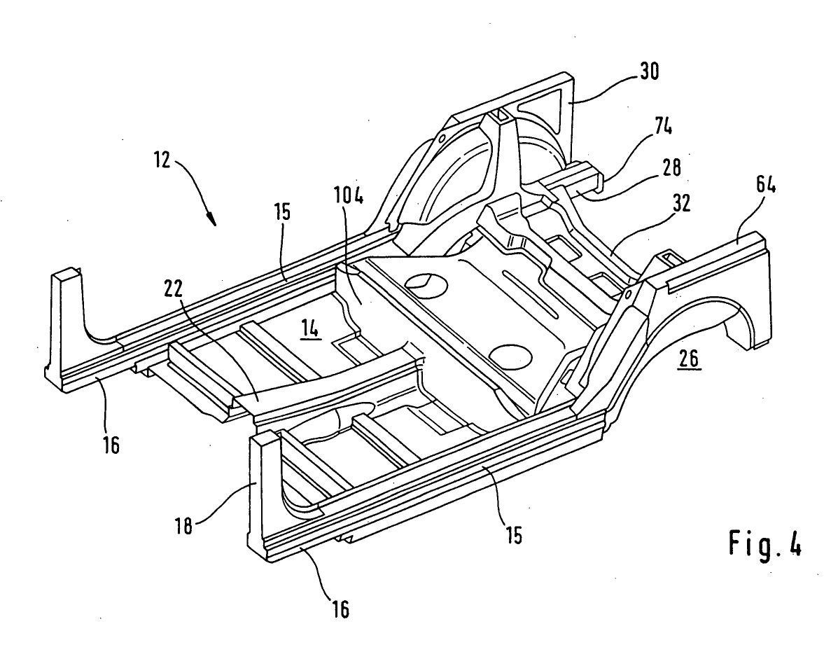

A basic module 12 of the support structure 10, which basic module can be seen in an overall view of FIG. 1 and in FIG. 4, essentially comprises a body floor 14 which is bounded laterally by longitudinal members 15. The basic module 12 reaches forward with longitudinal member sections 16 as far as column sections 18 of front wall columns 20 which protrude upward from the respectively assigned, front ends of the lateral longitudinal member sections 16. The body floor 14 of the basic module 12 ends at a considerable distance behind the front end of the basic module 12 or behind the column sections 18 of the front wall columns 20. In this case, the body floor 14 is provided here with a central tunnel 22 and with crossmembers 24 which extend outward from said tunnel and are connected fixedly to the longitudinal members 15. At the rear, the basic module 12 ends behind rear wheel houses 26, to the inside of which extensions 28 of the lateral longitudinal members 15 extend. Above the rear wheel houses 26, wall regions 30 of the particular, rear side wall are arranged. The body floor 14 ends at the rear at a crossmember 32 which extends between the extensions 28 of the lateral longitudinal members 15 in the transverse direction of the vehicle level with the rear wheel houses 26. The basic module 12 is already equipped as far as possible with the other partial modules before the joining together. Thus, for example, the inner lining, possibly the seat system, the electric and electronic device, or the underfloor system, e.g. with parts of the exhaust system, are already attached to the basic module and provided, if appropriate, with adapters, plug-in connections or the like which permit a connection to further components.

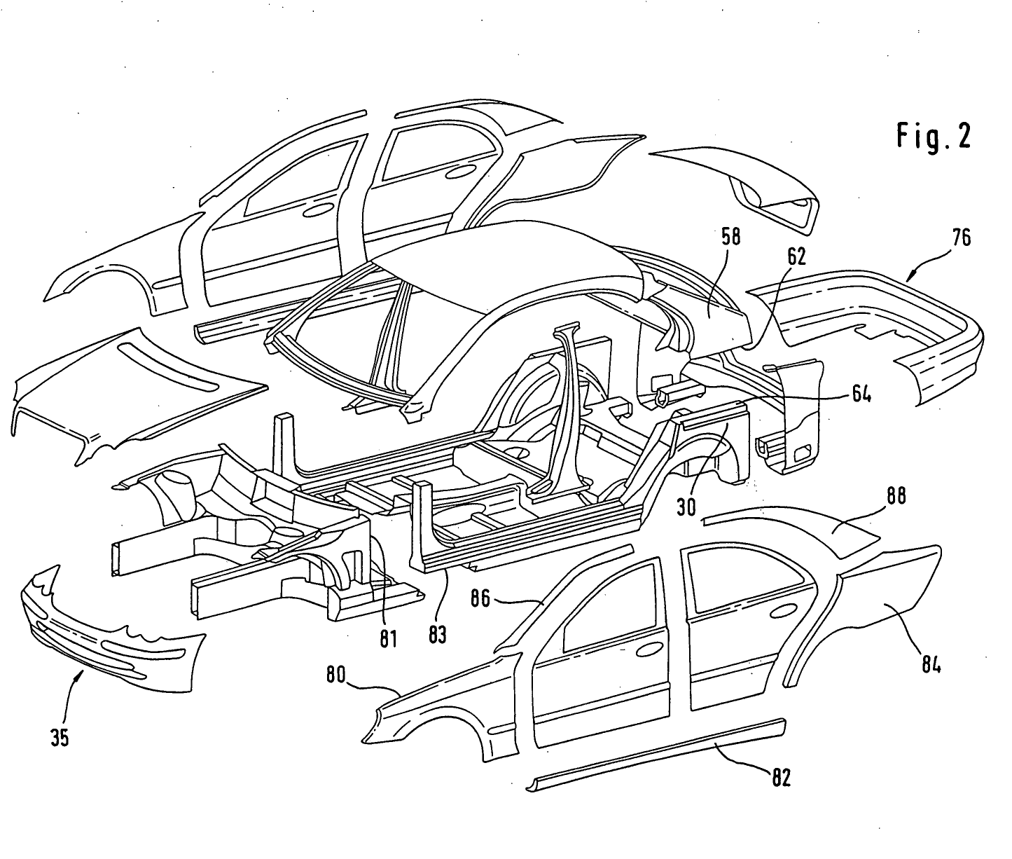

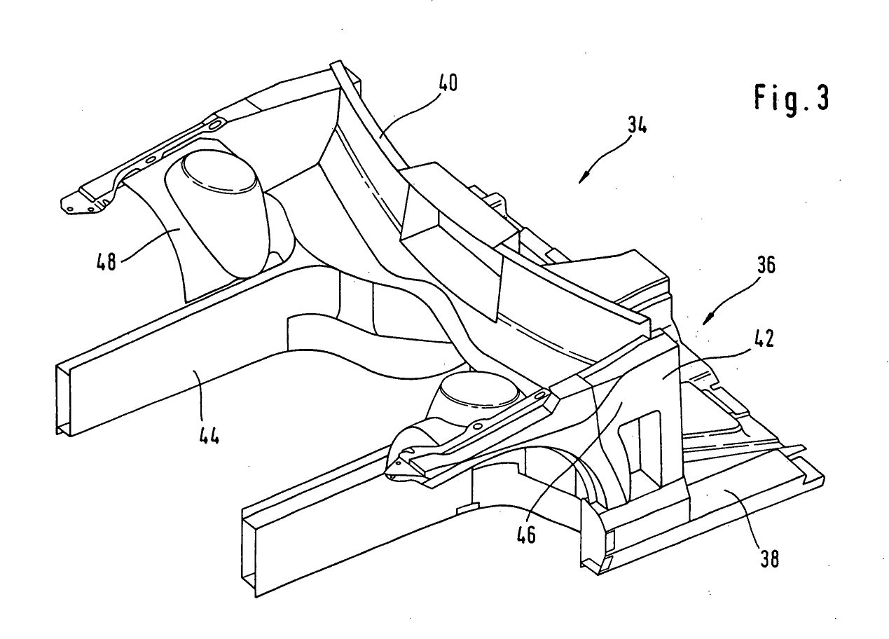

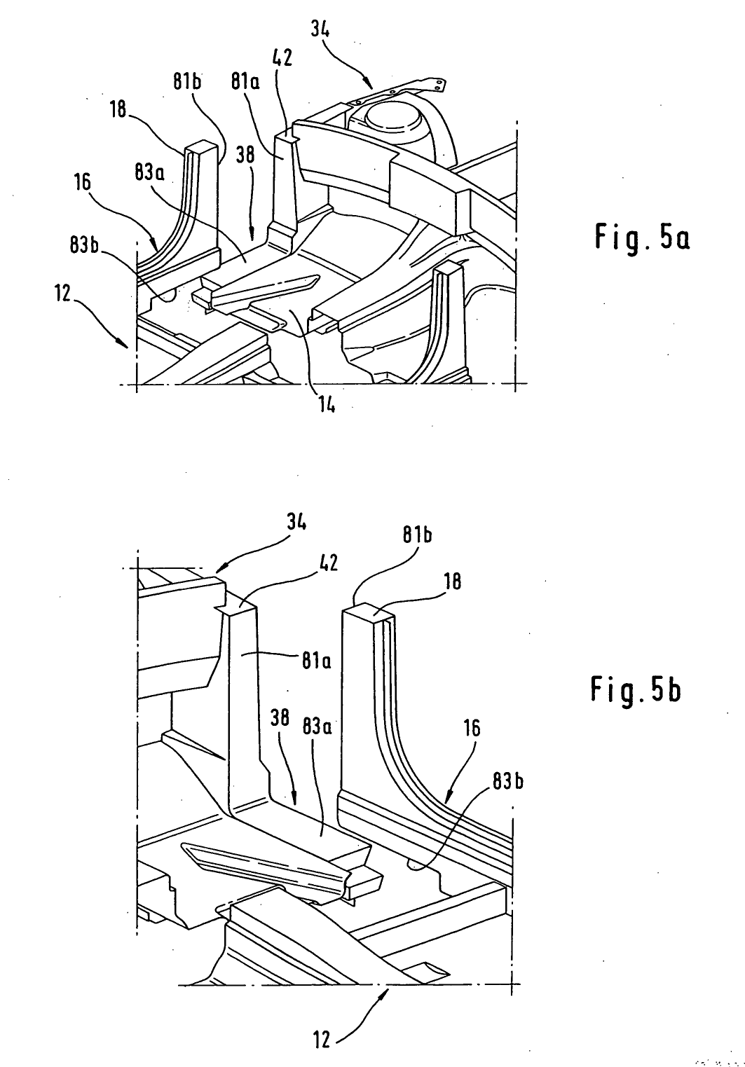

A front end module 34, which can be seen in an overall view in FIG. 3, belongs to the front crumple zone of the motor vehicle and is supported on the basic module 12 in a crash stable manner is connected to the basic module 12. For this purpose, the front end module 34 comprises a front end region 36 of the body floor 14 which extends between lateral longitudinal member sections 38 of the front end module 34. As can be seen from the views of FIGS. 3, 5a and 5b, the front end region 36 of the body floor 14 and the lateral longitudinal member sections 38 end at least approximately level at the rear. At the front, the front end region 36 of the body floor 14 ends at a front end wall 40 of the passenger cell, extending from the front end region 36 of the body floor 14 as far as approximately level with the side wall edge of the support structure 10. The end wall 40 is bounded laterally by column sections 42 of the front wall columns 20 which protrude upward from the lateral longitudinal member sections 38 of the front end module 34. Front longitudinal members 44 and front side wall regions 46 can be seen at the front end of the front end module 34, between which members and regions parts 48 of the wheel house lining of the front wheel houses are arranged. At the front, the front end module 34 is adjoined by a front module 35, part of which is illustrated in FIG. 2. This front module 35 comprises, for example, the front bumper, the nose region of the motor vehicle, the headlamps, parts of the radiator and parts of the wheel house lining. Like the basic module 12, the front end module 34 is also already equipped as far as possible with the other partial modules before joining together. Thus, in particular, components and assemblies (not shown), such as the instrument panel, the air conditioning system, the pedal system etc, can already be attached to the front end module.

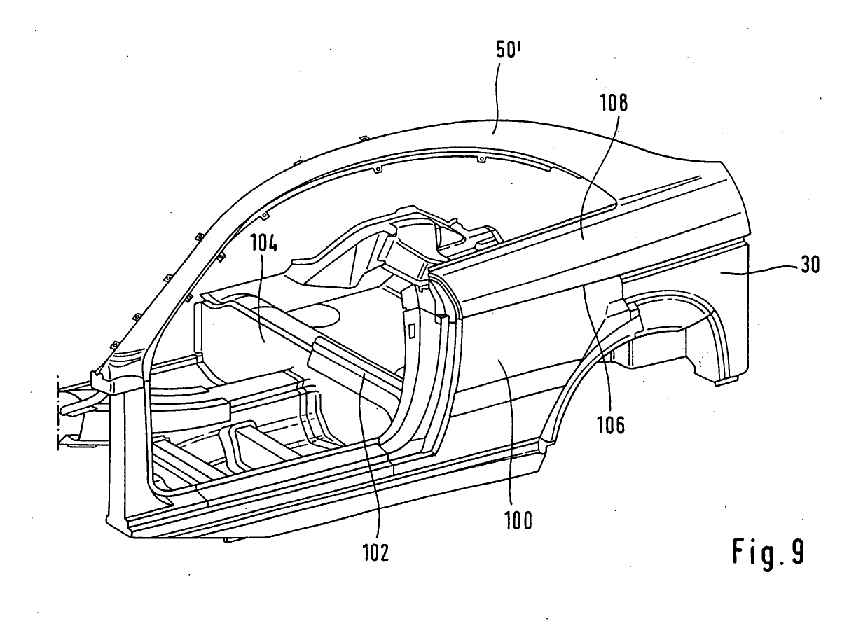

A roof module 50, which can be seen in the overall view of FIG. 9, can be placed onto the basic module 12 and the front end module 34 and here comprises lateral A-columns 54, lateral roof columns 56 in the region of the roof 52, and C-columns 58. The lower ends of the A-columns 54 and of the C-columns 58 are connected to one another via a respective crossmember element 60. When the support structure 10 is assembled, the A-columns 54 are supported both on the basic module 12 and on the front end module 34. In other words, the A-columns 54 are supported at their lower ends both on the upwardly protruding column sections 18 and 42 of the basic module 12 and of the front end module 34, which form the particular front wall column 20. At the rear, joining surfaces 62 of the lower ends of the C-columns 58 are fastened with joining surfaces 64 to the respectively assigned, upper end of the wall regions 30, for example by means of a bonding connection.

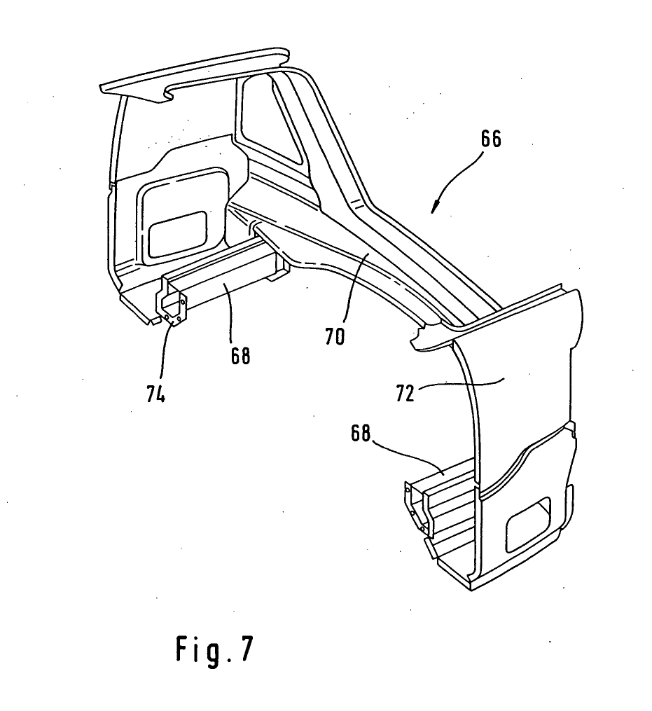

At the rear, the basic module 12 is adjoined by a rear module 66, which can be seen in the overall view of FIG. 7 and which, when the support structure 10 is assembled together with the rear end region of the basic module 12, belongs to the rear crumple zone of the motor vehicle and essentially comprises lateral, rear longitudinal member sections 68, a rear crossmember 70 connecting the longitudinal member sections 68 and rear side wall regions 72. When the support structure is assembled, the crossmember 32 and the longitudinal member extensions 28 of the basic module 12 and the longitudinal member sections 68 and the rear crossmember 70 of the rear module 66 form a supporting frame within which a spare wheel trough (not shown) can be fixed. It is apparent that the rear module 66 is connected to the basic module 12 and the roof module 50 along a transverse plane of the vehicle that runs vertically. The rear module 66 is fastened to the basic module 12 and the roof module 50 via flanges 74 on the longitudinal member extensions 28 or on the associated longitudinal member sections 68, and via further joining points (not shown) between the modules 12, 50 and 66. To the rear, the rear module 66 is adjoined by a rear end module 76, part of which can be seen in FIG. 2. This rear end module 76 comprises, for example, the rear bumper or the rear lighting of the motor vehicle. It is to be regarded as a matter of course that both the roof module 50 and the rear module 66 can already be equipped as far as possible with linings, assemblies and components before the support structure 10 is joined together.

In the case of the five-door motor vehicle shown here, a respectively assigned B-column 78 is fastened between the lateral roof column 56 of the roof module 50 and the lateral longitudinal member 15 of the basic module 12.

FIG. 2 illustrates, in a further perspective exploded illustration, the support structure 10 which is made of the partial modules 12, 34, 50, 66 and is lined with outer panel parts of plaster, sheet metal or the like. Front wing linings 80, in particular, are thus designed in such a manner that the joining point 81 between the upwardly protruding column sections 18 and 42 of the basic module 12 and of the front end module 34 is covered and cannot be seen from the outside. In addition, the front wing linings 80 likewise cover the fastening points of the A-columns 54 of the roof module 50 to the basic module 12 and the front end module 34 and those fastenings points cannot be seen. Lateral sill linings 82 are designed in such a manner that the joining point 83 between the respective longitudinal member sections 16 of the basic module 12 and the longitudinal member sections 38 of the front end module 34 is covered in a manner such that it cannot be seen from the outside. Rear wing linings 84 are likewise designed in such a manner that the joining surfaces 62, 64 between the C-column 58 and the rear wall region 30 are likewise covered in a manner such that they cannot be seen from the outside. It is apparent that all of the joining points of the large-size partial modules 12, 34, 50 and 66 are therefore covered by the lining parts 80, 82, 84 and cannot be seen from the outside. This ensures that the partial modules can be joined with sufficient tolerances in a simple manner in terms of manufacturing and therefore cost-effectively and, on the other hand, the covering of the joining points conveys an impression of high quality.

The A-columns 54, the lateral roof columns 56 and the C-columns 58 are lined with column lining parts 86, 88.

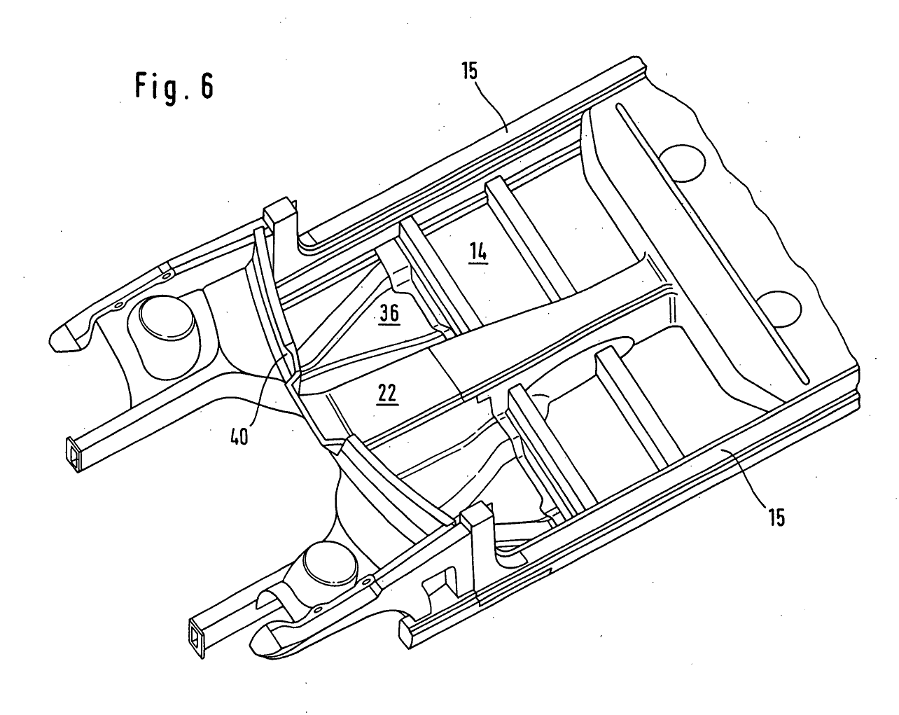

FIGS. 5a and 5b illustrate, in partial perspective views, the joining together of the basic module 12 and of the front end module 34, and FIG. 6 illustrates, in a perspective view, the basic module 12 and the front end module 34 after they have been joined together. It can be seen that the front end region 36 of the body floor 14, which region belongs to the front end module 34, extends rearward over a considerable length region of the basic module 12 between the lateral longitudinal member sections 16. It can furthermore be seen that the mutually assigned, lateral longitudinal member sections 16, 38 of the front end module 34 and of the basic module 12 have joining surfaces 83a, b, which are matched to each other, at the particular joining point 83 (FIG. 2), which joining surfaces extend over the at least approximately entire overlapping length of the mutually assigned longitudinal member sections 16, 38. In this case, the length of the joining surfaces 83a, b corresponds approximately to the length of the adjacent, front end region 36 of the body floor 14. The lateral longitudinal member sections 16, 38 of the front end module 34 and of the basic module 12 have a respective box profile which is closed in cross section, so that, after the longitudinal member sections 16, 38 which are assigned to each other in each case have been joined together, lateral longitudinal members having a box profile which is doubled in cross section and is approximately 8-shaped are produced. The box profile of the lateral longitudinal member sections 16, 38 of the front end module 34 and of the basic module 12 in each case has a cross section which can be varied over its length and here is stepped. Of course, it would also be conceivable in this connection for the longitudinal member sections 16, 38 to each be designed as a partial shell which are then connected to one another to form a support.

The upwardly protruding column sections 18, 42 of the basic module 12 and of the front end module 34 comprise joining surfaces 81a, b, which are matched in each case to each other, at the particular joining point 81 (FIG. 2), via which the column sections 18, 42 are connected to form the front wall column 20. The upwardly protruding column sections 18, 42 in each case comprise a box profile which is closed in cross section, so that after the respectively assigned column sections 18, 42 have been joined together, particularly stiff door columns 20 having a box profile, which is doubled in cross section and is approximately 8-shaped, are created. The joining surfaces 81a, b of the column sections 18, 42 and the joining surfaces 83a, b of the longitudinal member sections 16, 38 run here at least approximately at right angles to one another. The angular bonding of the column sections 18 to the longitudinal member sections 16 of the basic module 12 or the angular bonding of the column sections 42 to the longitudinal member sections 38 of the front end module 34 provides a particularly stiff supporting of the front end module 34 on the basic module 12. The position of the basic module 12 and of the front end module 34 is therefore determined in the longitudinal direction of the vehicle and in the vertical direction of the vehicle by the joining surfaces 83a, b and 81a, b. In the transverse direction of the vehicle, the position of the basic module 12 and of the front end module 34 is not determined by the joining surfaces 83a, b and 81a, b but rather, for example, by bearing surfaces of the basic module 12 and of the front end module 34 in the region of the central tunnel 22. The front end region 36 of the body floor 14, which end region belongs to the front end module, is connected in an overlapping manner to that region of the body floor 14 which belongs to the basic module 12, as is apparent in particular from FIG. 6. In this case, the central tunnel 22 is molded both into the front end region 36 and into the body floor 14 and is provided with joining surfaces.

Finally, FIG. 9 shows, in a partial perspective view, the assembled support structure 10 which comprises in each case a left and right side wall module 100, which extends from behind the front side doors as far as rear door pillars. The side wall module 100 is fastened to the basic module 12 above the assigned longitudinal member 15 and opposite the rear side wall 30. In addition, the side wall module 100 is supported in relation to a crossmember 104 by a supporting arrangement 102 in the transverse direction of the vehicle.

The basic module 12 and the side wall module 100 end level with a common joining surface 106 on which a different coupé roof module 50′ here is fixed with a side wall region 108.

1-18. (canceled)

19. A motor vehicle body having support structure which is composed of large-size partial modules comprising:
a basic module having lateral longitudinal members and a body floor, and reaching laterally as far as front wall columns; and
a front end module forming at least part of a front crumple zone of the motor vehicle and supported in a crash stable manner on the basic module when the support structure is assembled;
wherein a front end region of the body floor belongs to the front end module and extends rearward over a considerable length region of the basic module between lateral longitudinal member sections.

20. The body as claimed in claim 19, wherein the front end module comprises longitudinal member sections which laterally bound the front end region of the body floor and can be connected to the lateral longitudinal member sections of the basic module.

21. The body as claimed in claim 20, wherein the longitudinal member sections include mutually assigned, lateral longitudinal member sections of the front end module and of the basic module which have joining surfaces that are matched to each other and extend over at least approximately an entire overlapping length of the mutually assigned longitudinal member sections.

22. The body as claimed in claim 21, wherein the length of the joining surfaces corresponds approximately to the length of an adjacent, front end region of the body floor.

23. The body according to claim 20, wherein the longitudinal member sections of the front end module and the front end region of the body floor extend rearward to approximately the same distance.

24. The body as claimed in claim 20, wherein each of the longitudinal member sections of the front end module and of the basic module has a box profile which is closed in cross section.

25. The body as claimed in claim 24, wherein each of the box profiles of the longitudinal member sections of the front end module and of the basic module has a cross section which can be varied over its length.

26. The body as claimed in claim 19, wherein upwardly protruding column sections which can be connected to the front end module are arranged at the front ends of the lateral longitudinal member sections of the basic module.

27. The body as claimed in claim 21, wherein upwardly protruding column sections between which a front end wall is fastened are arranged on the lateral longitudinal member sections of the front end module.

28. The body as claimed in claim 19, wherein upwardly protruding column sections of the front end module and of the basic module can be connected to each other via joining surfaces, which are matched in each case to each other, to form front wall columns.

29. The body as claimed in claim 19, wherein upwardly protruding column sections of the front end module and of the basic module each have a box profile which is closed in cross section, and extend to approximately level with the side wall edge of the support structure.

30. The body as claimed in claim 19, wherein the front end region of the vehicle body floor which belongs to the front end module is connected in an overlapping manner to a region of the body floor which belongs to the basic module.

31. The body as claimed in claim 19, wherein the basic module ends behind rear wheel houses and can be connected to a rear module which, when the support structure is assembled together with the rear end region of the basic module, belongs to a rear crumple zone of the motor vehicle.

32. The body as claimed in claim 19, wherein a roof module can be placed onto the basic module and the front end module, and wherein front roof columns of the roof module can be supported both on the basic module and on the front end module.

33. The body as claimed in claim 32, wherein the roof module comprises a crossmember which runs below a windshield and via which front wall columns are connected to each other.

34. The body as claimed in claim 32, wherein a B-column can be fastened between the roof module and the basic module.

35. The body as claimed in claim 19, wherein a side wall module can be fastened in each case to the basic module above each longitudinal member and extends from behind a front side door as far as a rear door column.

36. The body as claimed in claim 19, wherein the support structure is to be lined with outer panel parts, and wherein joining points of the partial modules are to be covered by the outer panel parts.
